(19) United States
(12) Patent Application Publication
(10) Pub. No.: US 2021/0086482 A1
(43) Pub. Date: Mar. 25, 2021

(54) FLEXIBLE CERAMIC FILM

(71) Applicants: Janice JAKIELSKI, Sutton, MA (US); Joshua PERSKY, Sutton, MA (US)

(72) Inventors: Janice JAKIELSKI, Sutton, MA (US); Joshua PERSKY, Sutton, MA (US)

(21) Appl. No.: 16/578,230

(22) Filed: Sep. 20, 2019

(51) Int. Cl. B32B 18/00; C04B 35/63

(52) U.S. Cl. CPC B32B 18/00; C04B 35/63; C04B 2235/96; C04B 2237/341; C04B 2237/343

(57) ABSTRACT

In one aspect, a film is disclosed, which comprises at least one ceramic material, and a binder mixed with the ceramic material, where the film has a thickness in a range of about 0.01 mm to about 2.5 mm. The film is flexible with a minimum bend radius that is equal to or less than about 2 times a thickness of the film. By way of example, the minimum bend radius of the flexible film can be in a range of about the thickness of the film to about twice the thickness of the film. For example, in some embodiments, the minimum bend radius of the film can be in a range of about 0.02 mm to about 5 mm.

### BACKGROUND

The present teachings are generally related to ceramic films and methods for their fabrication.

Ceramics are employed in a variety of different applications. For example, ceramic clays are used to fabricate artwork, such as pottery, tableware, tiles, figurines, and sculpture. Conventional ceramics suffer, however, from a number of shortcomings. For example, conventional ceramics, when mixed with water, will generally not yield a plastic body and will have very low formability, e.g., the bend radius of a film formed of such ceramics when wet is typically many times greater than the film's thickness.

Although a variety of different ceramic materials are available, there is still a need for ceramic films that can be sufficiently flexible to be shaped into a variety of configurations and can retain their flexibility over long periods of time.

### SUMMARY

The present teachings provide flexible ceramic films that are flexible and highly formable into a variety of different shapes, for example, for use in generating artwork.

In one aspect, a film is disclosed, which comprises at least one ceramic material, and a binder mixed with the ceramic material, where the film has a thickness in a range of about 0.01 mm to about 2.5 mm, e.g., in a range of about 0.05 mm to about 2 mm, for example, in a range of about 1 mm to about 1.5 mm.

In some embodiments, the weight concentration of the ceramic material in the film can be, for example, in a range of about 35 percent to about 65 percent, e.g., in a range of about 40 percent to about 50 percent. Further, in some such embodiments, the weight concentration of the binder in the film can be, e.g., in a range of about 1% to about 10%. In some embodiments, the film can further include a dispersant, e.g., a surfactant.

The film is flexible with a bend radius equal to or less than about 2 times the thickness of the film. By way of example, the bend radius of the flexible film can be in a range of about the thickness of the film to about twice the thickness of the film. For example, in some embodiments, the bend radius of the film can be in a range of about 0.02 mm to about 5 mm.

In some embodiments, the flexible film can retain its flexibility, for example, as characterized by its bend radius, for at least about six months, for example, in a range of about six months to about 2 years. In some embodiments, the flexible film can retain its flexibility as characterized by its bend radius for a time duration in a range of about 2 years to about 5 years.

In some embodiments, the flexible film can further include a quantity of a glass powder. In some such embodiments, the glass powder can include at least one colorant oxide. By way of example, the colorant oxide can be any of a transition metal oxide and a rare earth oxide. In some embodiments, the film can include a ceramic colorant. In some embodiments, the weight concentration of the ceramic colorant in the flexible film can be, for example, in a range of about 0% to about 10% by mass of base ceramic (white).

In some embodiments, the ceramic material can be any of porcelain, stoneware, earthenware, and/or terracotta. In some embodiments, the binder material can include any of ammonium polyacrylate, starch, cellulose, and latex.

In some embodiments, the flexible film can include a plurality of different ceramic materials. For example, the flexible film can include porcelain and stoneware. By way of example, in some such embodiments, the weight concentration of the ceramic material contained in the flexible film can be divided equally between two or more ceramic materials, though in other embodiments, the weight concentration of one ceramic component can be different than that of another ceramic component.

In some embodiments, the ceramic material contained in the film can be in the form of a ceramic powder. In some such embodiments, the ceramic powder can include ceramic particles with average size dimensions (e.g., diameter in the case of spherical particles) in a range of about 0.1 micrometers (μm) to about 50 μm, e.g., in a range of about 1 μm to about 10 μm, e.g., in a range of about 2 μm to about 5 μm.

By way of example, in some embodiments, the ceramic material can include sodium aluminum silicate. In some such embodiments, the weight concentration of the sodium aluminum silicate in the film can be, for example, in a range of about 60% to about 80%. In some embodiments, the ceramic material can include silica. By way of example, in some such embodiments, the weight concentration of the silica in the film is in a range of about 15% to about 25%. In some embodiments, the ceramic material can include Al₂O₃.2SiO₂.2H₂O. In some such embodiments, the weight concentration of the Al₂O₃.2SiO₂.2H₂O in the film can be, for example, in a range of about 3% to about 45%. In some embodiments, the ceramic material can include alumina. In some such embodiments, the weight concentration of the alumina in the film can be, for example, in a range of about 8% to about 25%.

In a related aspect, a flexible tape is disclosed, which includes at least one ceramic material, and a glass powder mixed with said ceramic material, where a thickness of the tape is in a range of about 0.01 mm to about 2.5 mm. In some embodiments, the weight concentration of the ceramic material in the tape is in a range of about 35% to about 65%. Further, in some such embodiments, the weight concentration of the glass powder in the flexible tape is in a range of about 0% to about 100%. In some embodiments, the tape can exhibit a bend radius in a range of about 0.02 mm to about 5 mm. In some embodiments, the tape can further include a binder, and optionally a plasticizer, such as Poly(methacrylic acid sodium salt) or ammonium salt Glycerine and at weight concentrations disclosed herein.

In a related aspect, a method of fabricating a ceramic film is disclosed, which includes forming a mixture of at least one liquid, at least one dispersant, and a powder of at least one ceramic material, wherein a weight concentration of said at least one ceramic material in the mixture is in a range of about 35% to about 65%, subjecting the mixture to a high shear to form a slurry, and subsequently, casting the slurry so as to form a ceramic film. In some embodiments, the step of forming the mixture can include mixing the liquid and the dispersant, and adding the powder of at least one ceramic material to the mixture of the liquid and the dispersant. In some embodiments, a defoamer can also be added to the mixture of the liquid and the dispersant.

In some embodiments, the step of subjecting the mixture to high shear comprises subjecting the mixture to ball milling. In some embodiments, the method further comprises adding a binder to the mixture prior to the step of subjecting the mixture to high shear.

In some embodiments, the mixture is subjected to additional mixing after the step of adding the binder and the defoamer and prior to the step of subjecting the mixture to the high shear.

In some embodiments, prior to casting the mixture, the mixture is de-aired.

In some embodiments, subsequent to subjecting the mixture to high shear to form a slurry and prior to de-airing and casting the slurry, a defoamer can be further added to the slurry. In some embodiments, the weight concentration of the binder in the slurry can be, for example, in a range of about 1% to about 10%. Further, in some embodiments, the weight concentration of the defoamer in the slurry can be in a range of about 0.5% to about 2.5% by mass of liquid phase. As noted above, in some embodiments, a plasticizer can also be optionally employed. In some such embodiments, the weight concentration of the plasticizer in the slurry can be, for example, in a range of about 0.5% to about 2.5% by mass of the liquid phase.

In some embodiments, the above method is performed without using a toxic solvent, such as methyl ethyl ketone (MEK), xylene, ethyl acetate, ethanol and toluene. Instead, in some embodiments, the solvent can be water.

Further understanding of various aspects of the present teachings can be obtained with reference to the following detailed description in conjunction with the associated drawings, which are described briefly below.

### BRIEF DESCRIPTION OF THE DRAWINGS

FIG. 1 is a schematic depiction of a ceramic film according to an embodiment,

FIG. 2 schematically depicts that a flexible film according to the present teachings is sufficiently flexible to be bent with a small bend radius,

FIG. 3 is a flow chart depicting various steps in a method according to an embodiment for fabricating a ceramic flexible film according to the present teachings,

FIG. 4 shows data corresponding to viscosity of a slurry formed in accordance with the present teachings as a function of shear rate,

FIG. 5 shows fired laminated pieces of a plurality of ceramic films according to an embodiment of the present teachings, and

FIG. 6 shows an image of fired quilled ceramic pieces according to an embodiment of the present teachings.

### DETAILED DESCRIPTION

The present teachings are generally directed to flexible ceramic films (herein also referred to as ceramic sheets and tapes in some embodiments), which include one or more ceramic materials and at least one binder. In many embodiments, the ceramic films are sufficiently flexible to allow bending them with a small bend radius. In some embodiments, a flexible tape including one or more ceramic materials (e.g., one or more ceramic powders) and a glass powder is disclosed. Such ceramic sheets, tapes and films retain their flexibility for long periods of time and can be cut, shaped and bonded together to form a variety of different two-dimensional (2D) and three-dimensional (3D) structures.

Various terms are used herein according to their ordinary meanings in the art.

The term “ceramic” refers to a material composed of any Group I (alkali Metal), Group II (alkaline earth metal), transition metal, post transition metal, metalloid, lanthanide, or actinide bound to carbon, nitrogen, or oxygen or other reactive nonmetal. These are typically covalently or ionically bound materials. In the embodiments disclosed herein, the ceramic materials include oxides.

The term “porcelain” is a general term for a clay body (traditional ceramic) exhibiting a translucent body. Typical compositions for such a clay body include: 5 parts Kaolin, 3 parts feldspar, and 2 parts silica (flint).

The term “substantially” as used herein refers to a deviation of at most 5% from a complete state or condition. The term “about” as used herein with respect to a numerical value is intended to indicate a variation of at most 5%.

The term “bend radius” as used herein refers to a minimum radius one can bend a pipe, a tube, or sheet without damaging it (e.g., tearing it).

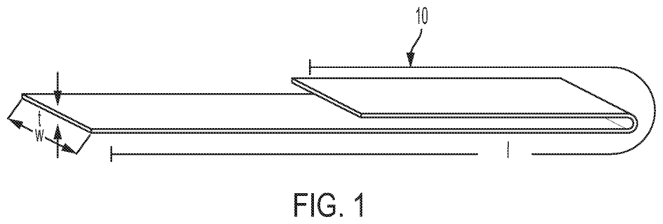

FIG. 1 schematically depicts a sheet (herein also referred to as a film or a tape) 10 according to an embodiment. In some embodiments, the sheet 10 can include a ceramic material and a binder that is mixed with the ceramic material. A variety of ceramic and binder materials can be employed. By way of example, in some embodiments, the ceramic materials can be any of porcelain, stoneware, earthenware, and terracotta. Further, in some embodiments, the binder can be any of ammonium polyacrylate, starch, cellulose and/or latex.

The flexible sheet 10 can be formed in a variety of shapes and sizes. By way of example, the flexible sheet 10 depicted in FIG. 1 has a substantially rectangular shape with a length (l), for example, in a range of about 1 cm to about 50 cm, and a width (w) in a range of about 1 cm to about 50 cm, though other sizes can also be employed. Further, the ceramic sheet 10 can have a thickness (t), for example, in a range of about 0.01 mm to about 2.5 mm. In other embodiments, the flexible sheet 10 can be formed into other shapes, such as triangles, circles, stars, etc.

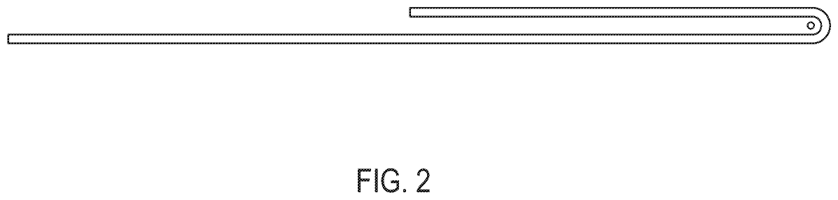

By way of illustration, FIGS. 1 and 2 schematically depict the ceramic film 10 in a bent configuration in which the sheet is bent around its length dimension. The dimensions depicted in FIG. 2 are for illustration purposes and should not be construed as limiting the scope of the invention. As shown schematically in FIG. 2, in some embodiments, the ceramic sheet 10 is sufficiently flexible such that it can be bent with a bend radius less than about 2 times the film's thickness. By way of example, in some embodiments, the bend radius of the flexible sheet 10 can be in a range of about 0.02 mm to about 5 mm, e.g., in a range of about 0.05 mm to about 4 mm, or in a range of about 1 mm to about 3 mm, such as 2 mm. In the embodiment depicted in FIG. 2, the bend radius is about 1 mm. Thus, the ceramic film 10 can be made as a thin and flexible sheet while exhibiting great resistance to tearing.

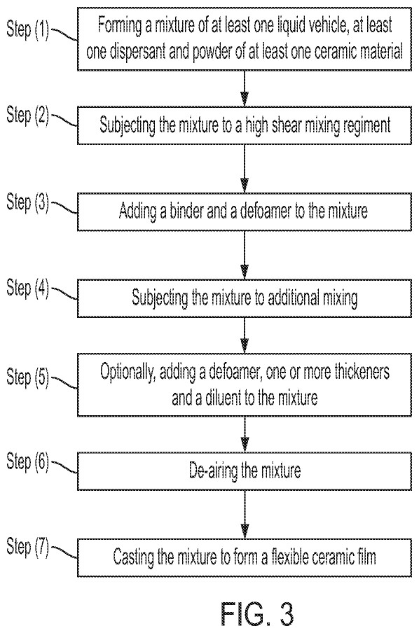

FIG. 3 depicts a flow chart indicating various steps in a method according to an embodiment for generating a flexible ceramic sheet, such as the sheet 10, according to the present teachings. Specifically, a mixture of at least one liquid vehicle (e.g., water), at least one dispersant, and a powder of at least one ceramic material is formed (step 1). In some embodiments, the weight concentration of the ceramic material in the mixture can be, for example, in a range of about 35% to about 65%, e.g., in a range of about 40% to about 50%. The weight concentration of the liquid vehicle in the mixture can be, for example, in a range of about 30% to about 60%, e.g., about 50% Further, the weight concentration of the dispersant in the mixture can be, for example, in a range of about 0.1% to about 1% by mass of the ceramic phase. In some embodiments, a plasticizer, such as those disclosed herein, can also be added to the mixture, e.g., at a weight concentration in a range of about 0.5% to about 2.5% by mass of the liquid phase.

As noted above, a variety of ceramic materials can be employed, such as those listed above. In some embodiments, a mixture of two or more ceramic materials (e.g., two or more different ceramic powders) can be employed. By way of example, in some such embodiments, the ceramic mixture can include Grolleg clay, Minspar 200 and Flint 325 #52. In some embodiments, the ceramic material can also include a ceramic colorant and/or a glass powder. In some such embodiments, the glass powder can include colorant oxides, such as transition and rare earth metal oxides. In some embodiments, a combination of clear glass and colored glass powder can be employed.

In some embodiments, the mixture of the ceramic material, the liquid vehicle and the dispersant can be formed by initially mixing the liquid vehicle with the dispersant and then adding the ceramic powder to that mixture.

The mixture can then be subjected to a high shear mixing regimen (step 2) to form a slurry. By way of example, in some embodiments, such mixing of the mixture can be achieved via ball milling or using a high shear mixer. By way of example, in some embodiments, the mixture can be subjected to such mixing for a time period in a range of about 2 to about 16 hours.

In this embodiment, a binder and a defoamer can be added to the slurry (step 3). Alternatively or in addition, at least a binder and a defoamer can be added to the mixture prior to the formation of the slurry. Further, optionally, a plasticizer can also be added to the slurry. A variety of binders and plasticizers, such as those listed herein, can be utilized. Further, in some embodiments, the defoamer can be any suitable defoamer. The commercially available defoamers generally fall into the following three categories: silicone-based, oil-based and polymer-based defoamers. Some examples of suitable commercially available defoamers are FoamStar S1 and Foammaster marketed by BASF of Germany. In some embodiments, the slurry can then be optionally subjected to additional mixing (step 4), e.g., for a time duration in a range of about 2 to about 4 hours. For example, similar to the first mixing regimen, the slurry can be subjected to ball milling.

In some embodiments, subsequently, a defoamer, one or more thickeners and a diluent (e.g., water) can be optionally added to the slurry (step 5). Some suitable examples of thickeners include, without limitation, methylcellulose, gelatin, xanthan gum, acetylated di-starch phosphates, dicylohexylamine, and acrylic copolymers and polyacrylic acid.

Subsequently, the slurry can be de-aired (step 6) and can be cast, e.g., tape cast, so as to form a flexible ceramic film (step 5). In some embodiments, de-airing of the slurry is accomplished by placing the slurry inside an evacuated chamber for several minutes. Typically, a vacuum greater than about 500 mm Hg will be applied. The pressure will be preferably reduced to about 25 mm Hg, where water will boil at room temperature ensuring no entrapped air. In some embodiments, the de-airing process can take about 5 minutes but the time duration can be highly dependent on the size of the vacuum pump and the chamber volume.

In some embodiments, a variety of known tape casting apparatuses can be employed for casting the slurry. By way of example, some such tape casting apparatuses feed a slurry to a doctor blade, which flattens and thins the cast surface. In other embodiments, other suitable tape casting apparatuses can be employed.

In many embodiments, a method according to the present teachings for fabricating flexible ceramic sheets (tapes/films) does not employ a toxic solvent, such as methyl ethyl ketone (MEK), xylene, ethyl acetate, ethanol and toluene. Rather, in some embodiments, water is employed as the solvent. As such, a method according to the present teachings can be practiced without adversely affecting the environment.

A flexible film according to the present teachings can provide a number of advantages. As noted above, conventional ceramics, when mixed with water, will generally not yield a plastic body and will have very low formability, e.g., the bend radius of a film formed of such ceramics when wet is typically many times greater that the film's thickness. In contrast, a flexible ceramic film according to the present teachings is flexible and is highly formable into a variety of different shapes For example, it can be cut, shaped and bonded together to form three-dimensional (3D) forms or expanded two-dimensional (2D) landscapes. As noted above, a flexible film according to the present teachings can retain its flexibility for a long period of time, even in some cases up to a few years. For example, a flexible film according to the present teachings can function similar to a soft slab in traditional ceramics, but it has the advantage of not drying out for long periods of time.

A thin ceramic film according to the present teachings in its unfired state is freed from many of the limitations of traditional porcelain, stoneware and terracotta clay bodies. Its flexibility, resistance to cracking and the fact that it does not dry out means that a variety of tools and processes, such as scissors, digital cutters, and laser cutters, can be used to manipulate and shape it. This makes working with the material more akin to working with paper.

By way of example, in some embodiments, a process of generating artwork using ceramic films according to the present teachings can include digitally designing the artwork using appropriate design software. On or more flat film sheets according to the present teachings can then be cut, e.g., using a laser or a digital cutter. The cut film sections can be laminated and assembled together before being fired in a pottery kiln.

In some embodiments, the thickness of a ceramic film according to the present teachings can be adjusted by laminating a plurality of ceramic sheets together. In some embodiments, household ammonia can be lightly brushed on the surfaces of the pieces to be laminated. The ammonia slightly breaks down the binder present in the films creating a tacky surface. The ceramic sheets can be stacked and pressed together using, for example, a rubber brayer to ensure full lamination and to prevent trapping of air bubbles. By layering various ceramic films according to the present teachings with different colors, interesting visual effects can be achieved.

Another processing technique draws from the craft of paper quilling. For this process, a thin film ceramic can be cut into small strips approximately ¼″ in width. These strips can be twirled, coiled and folded to create designs. The various components can be “glued” to each other using ammonia to break down the binder and create a tacky surface. Multiple colors of thin film can be combined to create interesting designs. After the sculpture is assembled it is loaded into a pottery kiln and fired to vitrification.

The finished designs made with thin film ceramic sheets can be loaded into a ventilated pottery kiln. The pieces can be fired immediately after their construction; there is no need to dry the film. The firing schedule can include a pre-heat, burn-out phase and maturation. A typical mid-range claybody firing protocol can be as follows: 200° F. per hour until reaching 200° F., hold for 0 hours; 500° per hour until 500°, hold for 1 hour; 100° per hour until 700°, hold for 1 hour; and 500° per hour until 2235° hold 10 minutes.

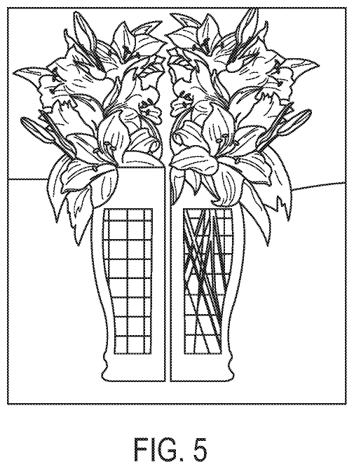

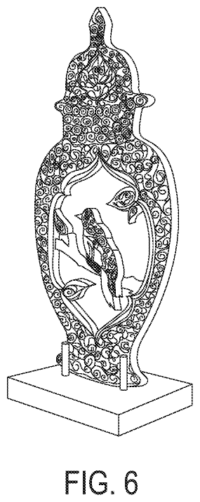

By way of example, FIG. 5 shows fired laminated pieces of a plurality of ceramic films according to the present teachings. Further, FIG. 6 shows an image of fired quilled piece.

### EXAMPLES

In this example, 765 g of water was mixed with 984 g of polyacrylic binder and 11 g of defoamer. The solution was mixed until binder and defoamer were dissolved. Under high shear (>1500 rpms using a 3 in dispersion style mixing blade produced by Ross Mixer), 775 g Grolleg ceramic was added. A few minutes later, 660 g feldspar (in this case Minspar 200) was added and mixing speed was increased to ˜2000 RPM. 505 g silica in form of flint powder was then added and mixing continued for ˜2 minutes at ˜2000 RPM (when preparing colored film the colorant oxides are added at this stage). The slurry had a viscosity of ˜500 cP at 30 RPM. A Brookfield #63 spindle was used to make the measurement.

The slurry was ball milled for 4 hours using zirconia media to ensure particles were well dispersed and the viscosity was confirmed. The material was then transferred back to the high shear mixer.

Additional 10 g of defoamer was added and mixed in. 7.7 g of diluted dicyclohexlamine was slowly added during high shear mixing. Mixing was continued for several minutes to ensure that the slurry was well homogenized. 7.7 g of Acrylic copolymer was then added until the viscosity reached ˜2500 cP. The slurry was transferred back to the ball mill and mixed for an additional 12 hrs at slow speed.

Prior to casting, the slurry was de-aired in a vacuum chamber for 5 minutes. The slurry was transferred to a casting machine. The gap on doctor blade of the casting machine was set to 1 mm and material was pulled through onto a plastic sheet. After forming the film, it was dried at 30° C. for 4 hours to remove the water and rendering the film ready for use.

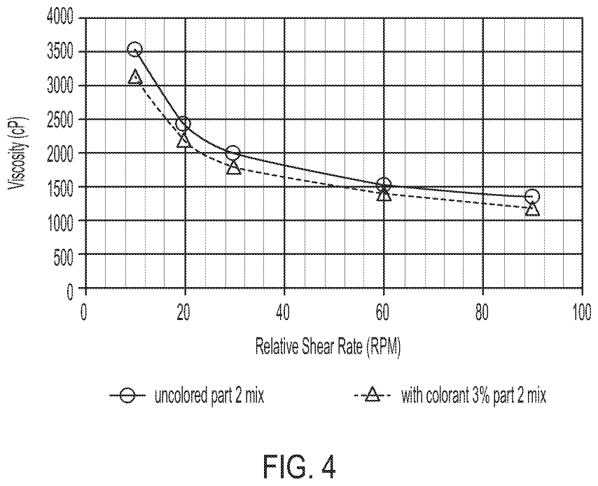

FIG. 4 shows viscosity data as a function of relative shear rate for two slurries formed in accordance with the above recipe, one without addition of a colorant and another with addition of 3% weight percent of Zirconium Vanadium blue from Mason Color #6315. The viscosity was measured after mixing and additional of thickeners and before casting, i.e., in a “ready to be cast” state.

Those having ordinary skill in the art will appreciate that various changes can be made to the above embodiments without departing from the scope of the invention as defined by the following claims.

1. A film comprising:
at least one ceramic material, said ceramic material comprising any of porcelain, stoneware, earthenware and terracotta, and
a binder mixed with said ceramic material,
wherein said film has a thickness in a range of about 0.01 mm to about 2.5 mm.

2. The film of claim 1, wherein said binder comprises any of ammonium polyacrylate, starch, cellulose, and latex.

3. The film of claim 1, wherein said film further comprises a plasticizer.

4. The film of claim 3, wherein said plasticizer comprises any of Poly(methacrylic acid sodium salt) or ammonium salt Glycerine.

5. The film of claim 1, wherein said film is flexible with a minimum bend radius equal to or less than about 2 times a thickness of the film.

6. The film of claim 5, wherein said bend radius of the film is in a range of about a thickness of the film to about 2 times a thickness of the film.

7. The film of claim 1, wherein said film is flexible and exhibits a minimum bend radius in a range of about 0.02 to about 5 mm.

8. The film of claim 7, wherein said film retains said bend radius for at least about six months.

9. The film of claim 8, wherein said film retains said bend radius for a time duration in a range of about six months to about 2 years.

10. The film of claim 1, further comprising a glass powder.

11. The film of claim 10, wherein said glass powder comprises at least one colorant oxide.

12. The film of claim 11, wherein said at least one colorant oxide comprises any of a transition metal oxide and a rare earth oxide.

13. The film of claim 1, further comprising a ceramic colorant.

14. The film of claim 1, wherein said at least one ceramic material comprises a plurality of different ceramic materials.

15. The film of claim 1, wherein a weight concentration of said at least one ceramic material is in range of about 35 percent to about 65 percent.

16. The film of claim 1, wherein said ceramic material comprises ceramic powder.

17. The film of claim 1, wherein said ceramic material comprises sodium aluminum silicate.

18. The film of claim 17, wherein a weight concentration of said sodium aluminum silicate in said film is in a range of about 60% to about 80%.

19. The film of claim 1, wherein said ceramic material comprises silica.

20. The film of claim 19, wherein a weight concentration of said silica in said film is in a range of about 15% to about 25%.

21. The film of claim 1, wherein said ceramic material comprises Al₂O₃.2SiO₂.H₂O.

22. The film of claim 21, wherein a weight concentration of said Al₂O₃.2SiO₂.2H₂O in said film is in a range of about 3% to about 45%.

23. The film of claim 1, wherein said ceramic material comprises alumina.

24. The film of claim 23, wherein a weight concentration of said alumina in said film is in a range of about 8% to about 25%.

25.-39. (canceled)
